(19) United States
(12) Patent Application Publication
(10) Pub. No.: US 2010/0147621 A1
(43) Pub. Date: Jun. 17, 2010

(54) SOUND ATTENUATING ARTICLES HAVING REBULKABLE NONWOVEN WEBS AND METHODS OF FORMING SAME

(76) Inventor: Samuel Mark Gillette, Burlington, NC (US)

Correspondence Address: MYERS BIGEL SIBLEY & SAJOVEC, PO BOX 37428, RALEIGH, NC, 27627, US

(21) Appl. No.: 12/639,506

(22) Filed: Dec. 16, 2009

Related U.S. Application Data
(60) Provisional application No. 61/122,942, filed on Dec. 16, 2008.

(51) Int. Cl. B32B 37/04; B29C 41/24; E04B 1/84

(52) U.S. Cl. 181/294; 264/165; 156/308.2

(57) ABSTRACT

A method of forming a sound attenuating material includes heating a densified, rebulkable nonwoven web at a sufficient temperature and for a sufficient time to rebulk the nonwoven web to an open, lofty form; compressing the rebulked nonwoven web to a predetermined thickness; and cooling the compressed nonwoven web at a sufficient temperature and for a sufficient time to cause the compressed nonwoven web to maintain the predetermined thickness. The cooled, compressed nonwoven web may further be formed into a desired shape. One or more additional layers of material may be laminated to the densified, rebulkable nonwoven web substantially simultaneously with the heating step. The nonwoven web may be heated to a temperature above the melt point of at least one component fiber of the nonwoven web and heating may be accomplished by heating one or both sides of the nonwoven web.

### RELATED APPLICATION

This application claims the benefit of and priority to U.S. Provisional Patent Application No. 61/122,942, filed Dec. 16, 2008, the disclosure of which is incorporated herein by reference as if set forth in its entirety.

### FIELD OF THE INVENTION

The present invention relates generally to sound attenuation and, more particularly, to sound attenuation materials and methods.

### BACKGROUND

Conventional sound attenuating materials, which by form and by function, are generally composed of relatively large, by aggregate volume, interstitial spaces filled with air within a fiber matrix. As such, these conventional materials are generally very bulky for their weight and volume, which may add costs to processing, handling, shipping, and storing. Accordingly, sound attenuating materials that are less bulky than conventional materials may be desirable, for numerous reasons.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention. In view of the above, sound attenuating materials are provided that are thin, easy to manufacture, and that are easy to handle, process, store and ship. According to some embodiments of the present invention, a sound attenuating article is constructed by laminating two or more thin layers of material, including an unbulked decoupler layer, a scrim layer, and other optional layers on high-speed, high-throughput lamination equipment, into a thin, easily handled composite. Variations of this embodiment include using multiple rebulkable layers of similar or dissimilar materials and/or properties in combination with various permeable and impermeable scrims and films. Sound absorption and/or sound insulation acoustical performance can be tuned to perform best at certain frequencies of sound or optimized to perform well over broad frequency ranges by using specific combinations of materials and by combining the properties from each constituent layer.

Embodiments of the present invention permit part manufacturers to die-cut parts from a composite article while an unbulked decoupler layer therein is still in a collapsed state. After the part has been die-cut, it can be shipped to an end user where it can be rebulked to a desired thickness by exposure to heat and subsequent cooling.

According to some embodiments of the present invention, a rebulkable web can include various means for bonding the web during installation. Exemplary means for bonding may include various adhesive agents including, but not limited to, heat-activatable adhesives in powder or coating form, and binder fibers.

According to some embodiments of the present invention, a method of forming a sound attenuating material includes heating a densified, rebulkable nonwoven web at a sufficient temperature and for a sufficient time to rebulk the nonwoven web to an open, lofty form; compressing the rebulked nonwoven web to a predetermined thickness; and cooling the compressed nonwoven web at a sufficient temperature and for a sufficient time to cause the compressed nonwoven web to maintain the predetermined thickness. The cooled, compressed nonwoven web may further be formed into a desired shape (e.g., via cutting, molding, etc.). In some embodiments, one or more additional layers of material may be laminated to the densified, rebulkable nonwoven web substantially simultaneously with the heating step.

The nonwoven web is heated to a temperature above the melt point of at least one component fiber of the nonwoven web. In some embodiments, the densified, rebulkable nonwoven web is heated by directing heated air to one or both sides of the nonwoven web. Alternatively, or in addition, the densified, rebulkable nonwoven web is heated by exposing one or both sides of the nonwoven web to convection heating.

In some embodiments, the compressed nonwoven web is cooled by directing cooled air to one or both sides of the compressed nonwoven web. Alternatively, or in addition, the compressed nonwoven web is cooled by contacting one or both sides of the compressed nonwoven web with a chilled platen or other similar device.

According to other embodiments of the present invention, a method of forming a sound attenuating article includes heating a densified, rebulkable nonwoven web that is in a multilayered composite at a sufficient temperature and for a sufficient time to rebulk the nonwoven web to an open, lofty form; compressing the multilayered composite such that the rebulked nonwoven web has a predetermined thickness; and cooling the compressed nonwoven web at a sufficient temperature and for a sufficient time to cause the compressed nonwoven web to maintain the predetermined thickness. The sound attenuating article may further be formed into a desired shape (e.g., via cutting, molding, etc.).

According to other embodiments of the present invention, multilayered composites are provided wherein one or more of the layers is a densified, rebulkable nonwoven web and wherein one or more of the layers comprises a layer of scrim (e.g., permeable scrim and/or impermeable scrim). The layers are arranged such that the multilayered composite attenuates sound at one or more predetermined frequencies.

According to other embodiments of the present invention, multilayered composites are provided wherein one or more of the layers is a densified, rebulkable nonwoven web and wherein one or more of the layers comprises a layer of film (e.g., permeable film and/or impermeable film). The layers are arranged such that the multilayered composite attenuates sound at one or more predetermined frequencies.

### BRIEF DESCRIPTION OF THE DRAWINGS

FIG. 1 illustrates a method of expanding a rebulkable nonwoven web, according to some embodiments of the present invention.

FIG. 2 illustrates a method of expanding a rebulkable nonwoven web according to other embodiments of the present invention and wherein a film or scrim is laminated to the nonwoven web to form a two-layer composite.

FIG. 3 illustrates a method of forming a sound attenuating article, according to some embodiments of the present invention.

FIGS. 4 and 5A are graphs that illustrates sound absorption characteristics of sound attenuating articles, according to some embodiments of the present invention.

FIG. 5B is a table of data used to generate the graph of FIG. 5A.

### DETAILED DESCRIPTION

The present invention will now be described more fully hereinafter with reference to the accompanying figures, in which embodiments of the invention are shown. This invention may, however, be embodied in many different forms and should not be construed as limited to the embodiments set forth herein. Like numbers refer to like elements throughout. In the figures, certain layers, components or features may be exaggerated for clarity, and broken lines illustrate optional features or operations unless specified otherwise. In addition, the sequence of operations (or steps) is not limited to the order presented in the figures and/or claims unless specifically indicated otherwise. Features described with respect to one figure or embodiment can be associated with another embodiment or figure although not specifically described or shown as such.

It will be understood that when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that although the terms first and second are used herein to describe various features/elements, these features/elements should not be limited by these terms. These terms are only used to distinguish one feature/element from another feature/element. Thus, a first feature/element discussed below could be termed a second feature/element, and similarly, a second feature/element discussed below could be termed a first feature/element without departing from the teachings of the present invention. Like numbers refer to like elements throughout.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The acoustic impedance of a material is defined as material density times acoustic velocity, and is expressed in units of Rayls (Newton-seconds/meter³). Acoustic impedance defines how easy it is for air to move through a material. Thus, for fibrous materials, acoustic impedance depends upon the density of the fibrous material and fiber diameter. Generally, the heavier the material and the finer the fibers, the higher the acoustic impedance. Moreover, thicker layers typically have more acoustic impedance than thin layers. The ability of a material to attenuate sound is conventionally defined by the material's STL, acoustic impedance, and absorption characteristics.

The term “rebulkable”, as used herein, refers to nonwoven webs which may be converted (at least once) from a densified or compressed state (i.e., a higher density/lower loft state) to an uncompressed state (i.e., a lower density/higher loft state).

The term “scrim”, as used herein, refers to a web of material with a specified air flow resistance between about 300 Rayls and about 4,000 Rayls, and a thickness less than about eight millimeters (8 mm).

The term “densified”, as used herein, refers to a compressed state, e.g., a rebulkable nonwoven web that has been compressed to a non-lofty form.

According to some embodiments of the present invention, rebulkable, nonwoven web materials, and methods of producing same, are provided for use as sound attenuating materials for various industries, such as, but not limited to, automotive, trucking, rail transportation, architectural interiors, consumer goods, office furniture, aircraft, aerospace, etc. As described below, handling, shipping and processing compressed fiber webs and composites and rebulking them just before final component manufacturing or assembly can result in substantial cost savings as compared with conventional materials.

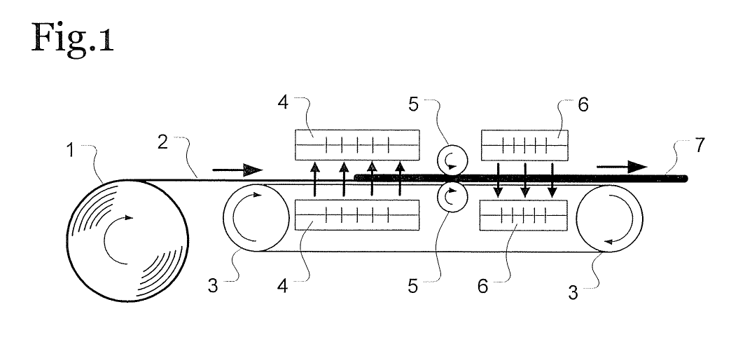

Referring to FIG. 1, a method of expanding a rebulkable nonwoven web, according to some embodiments of the present invention, is illustrated. The rebulkable nonwoven web typically comprises a multiplicity of first fibers and a multiplicity of second fibers which are entangled with each other and melt-bonded together, such as described in U.S. Pat. No. 5,198,057 to Newkirk et al., U.S. Pat. No. 6,312,484 to Chou et al., and U.S. Pat. No. 5,685,935 to Heyer et al., the disclosures of which are incorporated by reference in their entireties.

The first fibers are crimped, staple, thermoplastic organic fibers. The fibers, for example, may be stuffier-box crimped, gear crimped or helically crimped. A mixture of fibers having more than one crimp type is also within the scope of the invention. Suitable first fibers are made of, for example, polyester, polyamide, rayon or polyolefin. Suitable polyamides include, for example, polycaprolactam and poly(hexamethylene adipamide) (e.g., nylon 6 and nylon 6,6). Suitable polyolefins include, for example, polypropylene and polyethylene. In some embodiments, the first fibers are made of a polyester, such as polyethylene terephthalate.

The second fibers making up the rebulkable nonwoven web are typically bicomponent fibers comprising a first higher heat stable component and a second lower heat stable component. During formation of the rebulkable nonwoven web, the second component of the bicomponent fibers melts and adheres these fibers to the other fibers in the nonwoven web. The second component of the bicomponent fibers melts at a temperature lower than the melting or degradation temperature of the first component of the bicomponent fibers and at a temperature lower than the heat set temperature of the crimping process of the first fibers. In some embodiments, the melting temperature of the second component is at least about 130° C. in order to avoid excessive softening from exposure to temperatures of about 150° C., which are typically present during processing. In addition, the melting temperature of the second component, in some embodiments, is at least about 30° C. below the melting temperature of the first component of the bicomponent fibers. However, embodiments of the present invention are not limited to these particular melting temperatures.

The first component of the bicomponent fibers is typically selected, for example, from polyesters (e.g., polyethylene terephthalate), poly(phenylene sulfides), polyamides (e.g., nylon), polyimide, polyetherimide or polyolefins (e.g., polypropylene).

The second component of the bicomponent fibers typically comprises, for example, a blend of a crystalline or partially crystalline polymer and an amorphous polymer. As used herein the term “amorphous polymer” refers to a melt extrudable polymer that does not exhibit a definite first order transition temperature, (i.e., a melting temperature). The ratio of crystalline to amorphous polymer has an effect both on the degree of shrinkage of the nonwoven webs and the degree of bonding between the first and second components of the bicomponent fibers. The weight ratio of amorphous to partially crystalline polymer in the second component of the bicomponent fibers typically ranges from about 15:85 to about 90:10.

Suitable crystalline and amorphous polymers making up the second component of the bicomponent fibers are compatible with one another (i.e., exist in a single phase) or are capable of being rendered compatible. In addition, the second component is capable of adhering to the first component. The blend of polymers making up the second component of the bicomponent fibers includes crystalline and amorphous polymers of the same general polymeric type. Use of polymers of the same type for both the first and second components may produce bicomponent fibers that are more resistant to separation during fiber spinning, stretching, crimping, and during formation of nonwoven webs. Polymers suitable for use as the second component include, but are not limited to, polyesters, polyolefins, and polyamides. In some embodiments, polyesters may provide better adhesion than other classes of polymeric materials.

A compressed (densified) nonwoven web 2 having first and second fibers as described above is pulled from a roll form 1 by conveyor system 3. The compressed nonwoven web 2 is heated by a through-air system 4. Optionally, a radiant heater or contact heater system can be used to heat the conveyed web 2. Sufficient heat is applied to one or both sides of the web 2 to cause it to increase in thickness (rebulk to an open, loft form) to nearly its original thickness (prior to being compressed) before it reaches nip rollers 5. The heat applied is above the melt point of at least one of the thermoplastic fiber components in the web 2, but below the melt temperature of the remaining fiber components in the web 2. As such, the web 2 is allowed to expand as a result of the application of heat and the expansion of the crimped thermoplastic fibers.

The nip rollers 5 compress the heated, rebulked web 2 to the desired thickness and begin initial cooling. The web at this stage is referred to as 7 and is then cooled via through-air system 6 to a temperature which assures dimensional stability. This temperature is below the softening temperature of the lowest melt constituent material in the web 7. Optionally, the web 7 can be cooled by convection air or contact chilled platens, or by other methods. The expanded web 7 is then in-line die-cut or molded, or slit into die-cut/molding blanks.

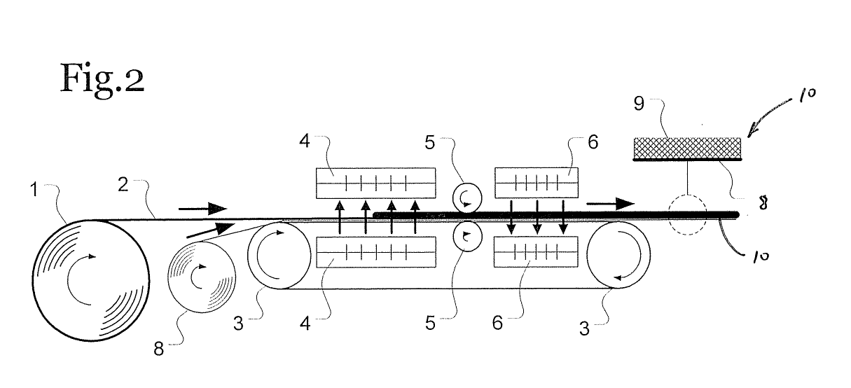

Referring to FIG. 2, a method of expanding a rebulkable nonwoven web, according to other embodiments of the present invention, is illustrated. A compressed nonwoven web 2 is pulled from a roll form 1 by conveyor system 3. A second layer 8, for example, a scrim, film or another rebulkable web material, is also pulled by conveyor system 3 and laminated to the web 2 at the same time as the web 2 is being expanded via the application of heat. Heat is applied to both layers via air system 4, as described above with respect to FIG. 1. Optionally, a radiant heater or contact heater system can be used to heat the conveyed web 2 and second layer 8.

Sufficient heat is applied to one or both sides of the web 2 to cause it to increase in thickness (rebulk to an open, lofty form) to nearly its original thickness (prior to being compressed) before it reaches nip rollers 5. For example, heat may be applied to the top side of the web 2 and/or to the opposite side through the second layer 8. The heat applied is above the melt point of at least one of the thermoplastic fiber components in the web 2, but below the melt temperature of the remaining fiber components in the web 2. As such, the web 2 is allowed to expand as a result of the application of heat and the expansion of the crimped thermoplastic fibers.

The nip rollers 5 compress the heated, rebulked web 2 to the desired thickness and begin initial cooling. The expanded composite web is composed of rebulked fiber 9 and laminated second layer 8 (e.g., scrim, film or second rebulkable layer, etc.) and is referred to at this stage as 10. The expanded composite web 10 is cooled via through-air system 6 to a temperature which assures dimensional stability. This temperature is below the softening temperature of the lowest melt constituent material in the web 10. Optionally, the web 10 can be cooled by convection air or contact chilled platens, or by other methods. The expanded web 10 is then in-line die-cut or molded, or slit into die-cut/molding blanks.

In some embodiments, the heating and cooling stages described with respect to FIG. 2 may serve to laminate the two layers 2, 8 together using a heat-activated adhesive applied to one or both of the layers. The adhesive is compatible with the fibers of the nonwoven web. Exemplary adhesives include, but are not limited to, conventional hot-melt adhesives (e.g., polyethylene-, polyamide-, polyester- and ethylene-vinyl acetate copolymer-based hot-melt adhesives); latex adhesives; acrylate adhesives; silicone adhesives and the like. Suitable adhesives may be in a powder, liquid, or film form. The adhesive could also be an additional nonwoven web or a layer of adhesive fibers on the surface of one or both of the composite layers 2, 8.

According to other embodiments of the present invention, additional layers (e.g., scrims, films and rebulkable nonwoven web layers) can be laminated to web 2, as needed. Embodiments of the present invention are not limited to the lamination of a single layer of material.

According to other embodiments of the present invention, rebulkable nonwovens webs of varying thicknesses and varying densities may be formed. For example, a composite could be made with the following layers: a thick and dense rebulkable nonwoven web, a heavy film, a thick and less dense rebulkable nonwoven web, a controlled air flow resistance film, a thin and low density rebulkable nonwoven web, etc.

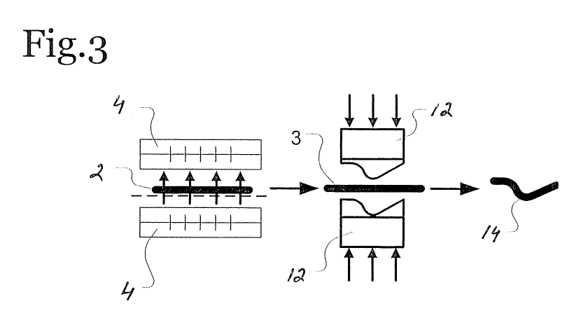

Referring to FIG. 3, another embodiment of the present invention is illustrated. A compressed web 2 is preheated and rebulked using a through-air system 4, as described above with respect to FIGS. 1 and 2. Optionally, a radiant heater or contact heater system can be used to heat the web 2 inline or heat a web blank. Sufficient heat over a given time frame is applied to one or both sides of the web 2 to cause it to increase in thickness (rebulk to an open, lofty form). The heated, rebulked web 3 is then placed in a three-dimensional chilled mold 12. As the mold 12 is closed and the hot fiber web 3 is formed into the cavities of the mold 12, the fiber web 3 cools quickly and thereby retains the shape of the mold cavity once the mold 12 is reopened and the part 14 removed. This process can easily be extended to include a plurality of other thermoplastic layers (scrims, films or other rebulked webs), with adhesives as required, that are preheated and together placed in the chilled mold 12.

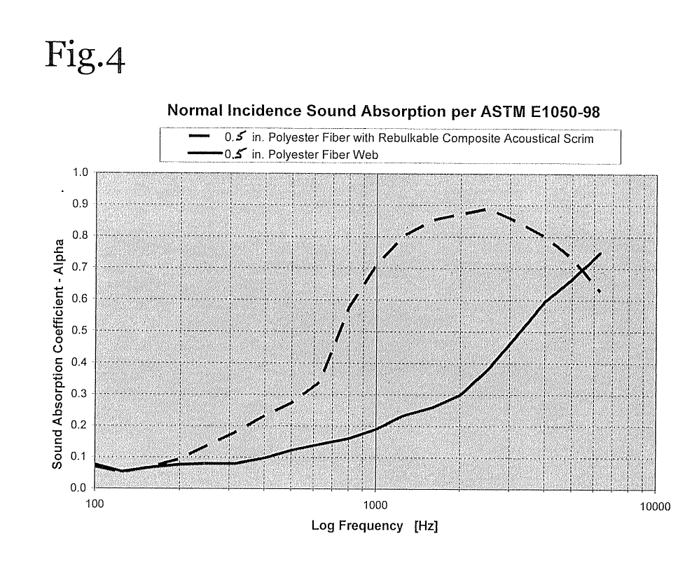

Referring to FIG. 4, the measured sound absorption results of a 0.5 inch (12.2 millimeter) airlaid polyester fiber web with and without a three-layer composite of rebulkable fiber/acoustic scrim/rebulkable fiber, according to embodiments of the present invention, that is placed on top of the polyester web, is illustrated. The three layer composite was made by thermally, adhesively or ultrasonically bonding a rebulkable fabric to both sides of a 100 gram/square meter (gsm) Evolon® brand microdenier fabric. The rebulkable fabric is composed of bicomponent polyester fibers with a fiber length of 1.79 inches and a thickness of 4.9. This exemplary fabric is made with fibers having a low melt sheath with a melting range between 115° C. to 120° C. and the fibers are crimped to reduce the fiber length by 14%. After carding the fibers, the rebulkable structure is thermally bonded by calendaring the fiber batt to a flat rebulkable fabric. Evolon® brand microdenier fabric is a spunbonded 25% nylon 75% polyester fabric consisting of fibers with pie shaped subdivisions. The fibers of the spunbonded web are subsequently split into smaller fibers using a spunlacing process.

By varying thicknesses, airflow resistances and basis weights of the composite, the point at which peak sound absorption occurs can be shifted toward desired frequencies. As such, methods of forming rebulked materials, according to embodiments of the present invention, allow sound attenuating materials/articles to be “tuned” to provide desired sound attenuating characteristics for various applications. The term “tuned” means that portions of a sound attenuating and/or absorbing material/article can be formed to have a specific acoustic impedance designed to attenuate sound in one or more frequencies or frequency bands, and/or to have a specific absorption characteristic designed to absorb sound in one or more frequencies or frequency bands. Moreover, sound attenuating/absorption materials/articles according to embodiments of the present invention may have reduced overall weight compared with conventional sound dissipating materials/articles, and without sacrificing sound attenuation properties.

According to other embodiments of the present invention, a rebulked fabric can be expanded to have a very low density and high thickness, such as a thickness ranging from 0.5 inch in space limited applications to greater than 6 inches for application such as buildings and auditoriums. In these applications the rebulkable fabric can be used to fill a chamber or space between predefined walls such as to damp vibrations in doors and enclosures. The rebulkable fabric can also have scrims applied to both the face and the back of the rebulkable fabric prior to the rebulking process, during the rebulking process or after the rebulking process. The scrim layer or layers would be designed to allow heat in the form of conduction, convection or radiation to pass through to allow for heating and expansion of the rebulkable web. The scrim/rebulkable fabric/scrim trilaminate has the advantage of absorbing sound from both sides when it is used in an open space. In addition to being used in tunable structures with specified air flow resistance, the rebulkable fabric can be used as a spacer fabric between impervious or pervious layers to keep the layers separated at a predetermined distance. In addition to having resistance to compression set the rebulkable fabric can be designed with resilient fibers to have a rapid recovery or spring back to its rebulked state so that it is suitable for use under carpets, in padded walls or inside of seat cushions.

### Example

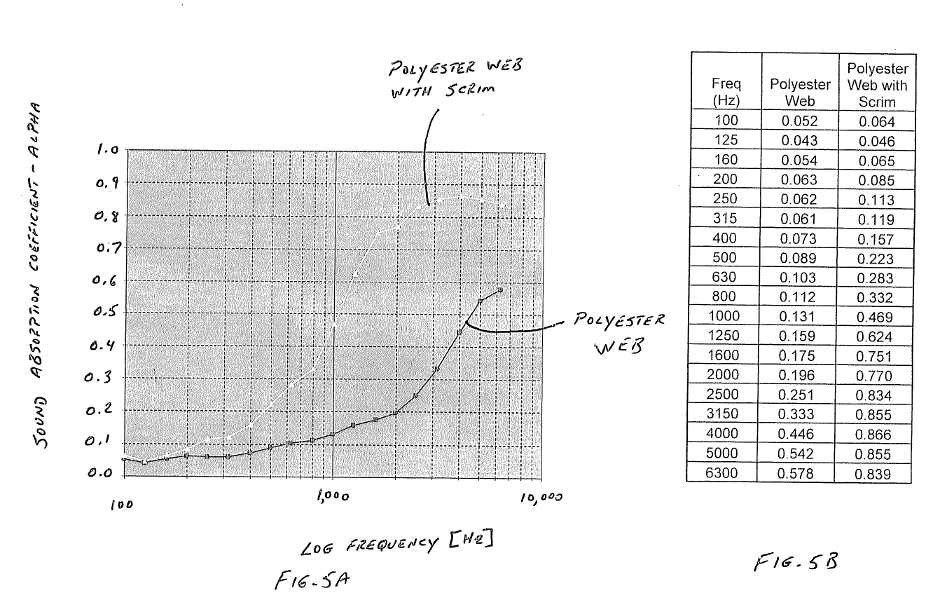

A 76.7 gsm (grams per square meter) rebulkable nonwovens fabric, Style S-313, manufactured by HDK Industries, Rogersville, Tenn., USA was adhesively laminated to both sides of a 100 gsm Evolon scrim (Freudenberg Nonwovens, Durham, N.C., USA) using around 1 gsm of 3M (3M Corporation, St. Paul, Minn., USA) Super 77 Spray Adhesive. The Style 313 has an air flow resistance of 32 Rayls and a thickness of 0.573 mm. The Evolon® brand microdenier fabric has an air flow resistance of 931 Rayls and a thickness of 0.46 mm (millimeter). The non rebulked composite was suspended in a forced air oven for 5 minutes at 300° F. and allowed to expand. The rebulked composite demonstrates a slightly lower air flow resistance than the Evolon scrim and, assuming that the Evolon scrim does not expand, it was determined that the rebulkable nonwoven expanded around 516%. When the rebulked composite was subsequently placed under some weight to simulate actual use conditions, loft was reduced so that it effectively expanded around 422%. The basis weight of the three layer composite was 254.4 gsm, the thickness was 1.64 mm and the air flow resistance was 1003 Rayls. After rebulking, the composite thickness changed to 7.56 mm and the air flow resistance changed to 826 Rayls. FIGS. 5A-5B illustrate sound attenuation data for this material.

The air flow resistance was measured in cubic feet per minute (cfm) on a TexTest FX3300 Air Permeability Tester III at 125 Pascal pressure drop and converted to Rayls using a proprietary algorithm (Rayls=24972*CFM ̂^{-1.0296}) The thickness was measured using ASTM 1777 with a 1 inch foot and with the weight removed from the tester.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

1-17. (canceled)

18. A method of forming a sound attenuating material, comprising:
heating a densified, rebulkable nonwoven web at a sufficient temperature and for a sufficient time to rebulk the nonwoven web to an open, lofty form;
compressing the rebulked nonwoven web to a predetermined thickness; and
cooling the compressed nonwoven web at a sufficient temperature and for a sufficient time to cause the compressed nonwoven web to maintain the predetermined thickness.

19. The method of claim 18, wherein the rebulkable nonwoven web comprises a plurality of crimped thermoplastic fibers and a plurality of bicomponent thermoplastic fibers entangled with the crimped thermoplastic fibers and melt-bonded to the crimped thermoplastic fibers.

20. The method of claim 19, wherein the crimped thermoplastic fibers comprise stuffer-box crimped fibers, gear-crimped fibers, and/or helically crimped fibers.

21. The method of claim 19, wherein the crimped thermoplastic fibers comprise polyester, polyamide, rayon, and/or polyolefin fibers.

22. The method of claim 19, wherein each bicomponent fiber comprises a first component and a second component, and wherein the second components of the bicomponent fibers are melt-bonded to the crimped thermoplastic fibers.

23. The method of claim 22, wherein the second component of each bicomponent fiber has a melting temperature below a melting temperature of the first component.

24. The method of claim 23, wherein the melting temperature of the second component is at least 30° C. below the melting temperature of the first component.

25. The method of claim 22, wherein the first component comprises polyester, poly(phenylene sulfide), polyamide, polyimide, polyetherimide, and/or polyolefin.

26. The method of claim 22, wherein the second component comprises a blend of a crystalline polymer and an amorphous polymer.

27. The method of claim 22, wherein the second component comprises a blend of a partially crystalline polymer and an amorphous polymer.

28. The method of claim 18, further comprising forming the cooled, compressed nonwoven web into a desired shape.

29. The method of claim 28, wherein forming the cooled, compressed nonwoven web into a desired shape comprises cutting a portion of the compressed nonwoven web and molding the cut portion.

30. The method of claim 18, further comprising laminating an additional layer of material to the densified, rebulkable nonwoven web substantially simultaneously with heating the densified, rebulkable nonwoven web.

31. The method of claim 30, wherein the additional layer of material comprises a densified, rebulkable nonwoven web, a layer of scrim, or a layer of film.

32. The method of claim 18, wherein heating the densified, rebulkable nonwoven web comprises directing heated air to one or both sides of the nonwoven web.

33. The method of claim 18, wherein heating the densified, rebulkable nonwoven web comprises exposing one or both sides of the nonwoven web to convection heating.

34. The method of claim 19, wherein heating the densified, rebulkable nonwoven web comprises heating the nonwoven web to a temperature above the melting point of at least the crimped thermoplastic fibers or the bicomponent thermoplastic fibers.

35. The method of claim 18, wherein cooling the compressed nonwoven web comprises directing cooled air to one or both sides of the compressed nonwoven web.

36. The method of claim 18, wherein cooling the compressed nonwoven web comprises contacting one or both sides of the compressed nonwoven web with a chilled platen.

37. A sound attenuating article, comprising a rebulkable nonwoven web having a plurality of crimped thermoplastic fibers and a plurality of bicomponent thermoplastic fibers entangled with the crimped thermoplastic fibers, wherein each bicomponent fiber comprises a first component and a second component, wherein the second component of each bicomponent fiber has a melting temperature below a melting temperature of the first component, and wherein the second components of the bicomponent fibers are melt-bonded to the crimped thermoplastic fibers.

38. The article of claim 37, wherein the crimped thermoplastic fibers comprise stuffer-box crimped fibers, gear-crimped fibers, and/or helically crimped fibers.

39. The article of claim 37, wherein the crimped thermoplastic fibers comprise polyester, polyamide, rayon, and/or polyolefin fibers.

40. The article of claim 37, wherein the melting temperature of the second component is at least 30° C. below the melting temperature of the first component.

41. The article of claim 37, wherein the first component comprises polyester, poly(phenylene sulfide), polyamide, polyimide, polyetherimide, and/or polyolefin.

42. The article of claim 37, wherein the second component comprises a blend of a crystalline polymer and an amorphous polymer.

43. The article of claim 37, wherein the second component comprises a blend of a partially crystalline polymer and an amorphous polymer.

44. The article of claim 37, further comprising a layer of scrim laminated to the rebulkable nonwoven web.

45. The article of claim 37, further comprising a layer of film laminated to the rebulkable nonwoven web.

46. The article of claim 37, further comprising a second rebulkable nonwoven web laminated to the first rebulkable nonwoven web, wherein the second rebulkable nonwoven web has a plurality of crimped thermoplastic fibers and a plurality of bicomponent thermoplastic fibers entangled with the crimped thermoplastic fibers, wherein each bicomponent fiber comprises a first component and a second component, wherein the second component of each bicomponent fiber has a melting temperature below a melting temperature of the first component, and wherein the second components of the bicomponent fibers are melt-bonded to the crimped thermoplastic fibers.

47. The article of claim 37, wherein the nonwoven web, when rebulked to an open, lofty form, attenuates sound at one or more predetermined frequencies.
